(19) United States
(12) Patent Application Publication
(10) Pub. No.: US 2026/0070439 A1
(43) Pub. Date: Mar. 12, 2026

(54) MODULAR CHARGING CONNECTOR

(71) Applicant: Jiangyin SINCEN Electronics Co., Ltd., Jiangsu (CN)

(72) Inventors: Zhenxing CAI, Jiangsu (CN); Qiyu LU, Jiangsu (CN)

(73) Assignee: Jiangyin SINCEN Electronics Co., Ltd., Jiangsu (CN)

(21) Appl. No.: 18/920,488

(22) Filed: Oct. 18, 2024

(30) Foreign Application Priority Data
Sep. 12, 2024 (CN) 202411277168.7

(51) Int. Cl. B60L 53/16; H01R 13/514; H01R 13/639; H01R 13/66

(52) U.S. Cl. CPC B60L 53/16; H01R 13/514; H01R 13/639; H01R 13/6683; B60L 2210/30

(57) ABSTRACT

A modular charging connector has an integrating body, a socket body, an AC-DC terminal parallel module, a thermoconductive temperature detecting module, and a ground and low voltage signal module. The integrating body is combined with the socket body, and accommodates the AC-DC terminal parallel module and the thermoconductive temperature detecting module. The thermoconductive temperature detecting module thermally contacts the DC/AC terminals of the AC-DC terminal parallel module, and detect the operating temperature by thermal conduction during charging. The ground and low voltage signal module is configured as a connector to be combined with the socket body and interlocked with the integrating body. The modular charging connector modularizes the main components, and uses the integrating body as the core to integrate the modules, thereby making assembly and production easier and conducive to automated layout.

### BACKGROUND OF THE INVENTION

### 1. Field of the Invention

The present invention relates to a charging connector, especially to a modular charging connector that can be easily assembled and can accurately sense the operating temperature regardless of DC fast charging (direct current fast charging) or AC slow charging (alternating current slow charging).

### 2. Description of the Prior Arts

SAE J3400 is a charging connector standard established by the International Society of Automotive Engineers. An interface of a socket includes two charging terminals, i.e. the charging terminal DC+/L1 and the charging terminal DC-/L2, a ground terminal G, and two signal terminals CP and PP. The two charging terminals DC+/L1 and DC-/L2 can be used for DC fast charging (direct current fast charging) or AC slow charging (alternating current slow charging). Since DC fast charging and AC slow charging are performed on the same set of charging terminals, the size of the SAE J3400 standard charging connector is significantly smaller. In this case, the structure of the connector must consider issues such as convenient outlet and insulation. On the other hand, since the two charging terminals DC+/L1 and DC-/L2 are charged with high-power power, the temperature changes are important monitored parameters. As the SAE J3400 standard charging connector is reduced in size, how to accommodate a sensing device that can simultaneously monitor the operating temperatures of the two charging terminals DC+/L1 and DC-/L2 in a limited space, and how the sensing device can accurately detect the temperatures of the two charging terminals DC+/L1 and DC-/L2 when charging, both challenge the efficiencies of the connector's internal space utilization and component combination.

Furthermore, in addition to the two AC-DC common charging terminals DC+/L1 and DC-/L2, a charging connector according to SAE J3400 also has a ground terminal G and two signal terminals CP and PP in the interface. Although the signal types of the terminals are different, they are placed close to together, wiring and isolation issues must also be considered in the structure. In addition, when the overall size is reduced, space utilization and the convenience of assembly must be considered.

To overcome the shortcomings, the present invention provides a modular charging connector to mitigate or obviate the aforementioned problems.

### SUMMARY OF THE INVENTION

The main objective of the present invention is to provide a modular charging connector that is configured to effectively integrate and modularize the components, making the charging connector more efficient in space utilization, easier to assemble, and can more accurately detect the operating temperature during charging.

The modular charging connector comprises an integrating body, a socket body, an AC-DC terminal parallel module, a thermoconductive temperature detecting module, and a ground and low voltage signal module.

The integrating body comprises an inner side and an outer side. A containing chamber is hollow and formed between the inner side and outer side.

The socket body is combined with the inner side of the integrating body and comprises a socket. The socket comprises a first charging terminal, a second charging terminal, a ground terminal and two signal terminals.

The AC-DC terminal parallel module comprises two DC terminals and two AC terminals. The DC terminals are respectively connected in parallel to an end of the first charging terminal and an end of the second charging terminal. The AC terminals are respectively connected in parallel to the end of the first charging terminal and the end of the second charging terminal. Parallel connecting parts are located in the containing chamber of the integrating body.

The thermoconductive temperature detecting module comprises two thermoconductive units and two temperature sensors. The thermoconductive units are mounted in the containing chamber of the integrating body and respectively thermally contact the parallel connecting parts of the DC terminals and/or the parallel connecting parts of the AC terminals. The temperature sensors are respectively mounted through the thermoconductive units.

The ground and low voltage signal module comprises an outer casing and a circuit board mounted in the outer casing. The ground terminal of the socket and the signal terminals of the socket are mounted in the outer casing. An end of the ground terminal and an end of each one of the two signal terminals pass out of the outer casing and are configured as a connector. Another end of the ground terminal and another end of each one of the two signal terminals are electrically connected to the circuit board of the outer casing.

The advantage of the present invention is that the main components are modularized and integrated into or combined with the integrating body, so as to fully utilize the limited space of the standardized charging connector and make assembly more convenient and efficient. For the operating temperature that needs to be closely monitored during the charging process, the thermoconductive temperature detecting module uses thermal conduction to sense the temperature of the AC-DC terminals in close proximity within the internal space of the integrating body, so that temperature monitoring can be performed accurately and conveniently.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a modular charging connector in accordance with the present invention;

FIG. 2 is another perspective view of the modular charging connector in FIG. 1;

FIG. 3 is an exploded view of the modular charging connector in FIG. 1;

FIG. 4 is a perspective view of the integrating body of the modular charging connector in FIG. 1;

FIG. 5 is another exploded view of the modular charging connector in FIG. 1;

FIG. 6 is an exploded view of the modular charging connector in FIG. 1;

FIG. 7 is a top view of the modular charging connector in FIG. 1; and

FIG. 8 is an exploded view of the ground and low voltage signal module of the modular charging connector in FIG. 1.

### DETAILED DESCRIPTION OF THE PREFERRED EMBODIMENTS

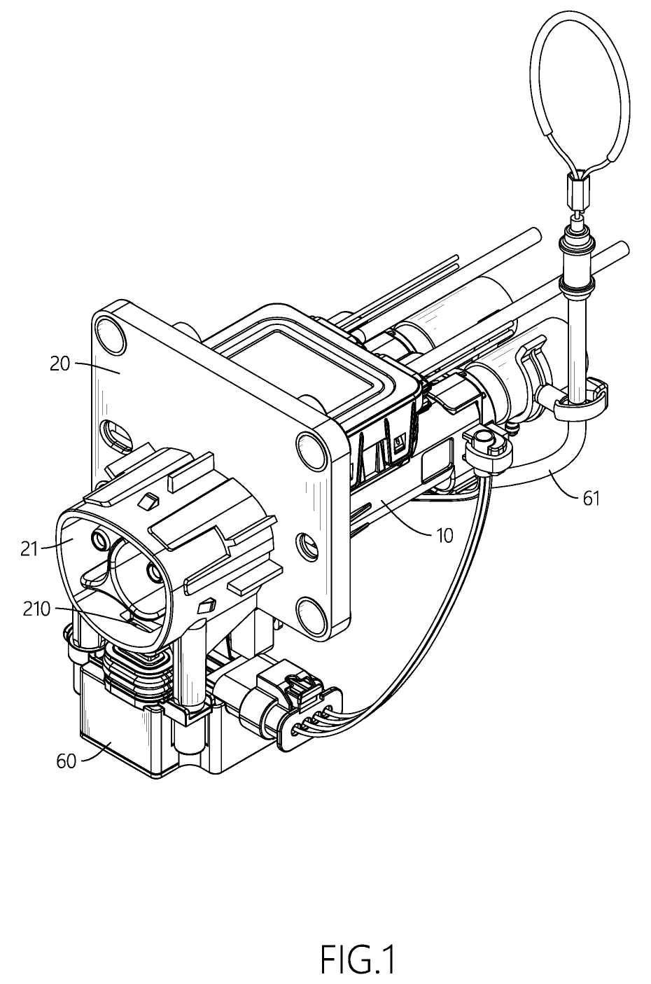

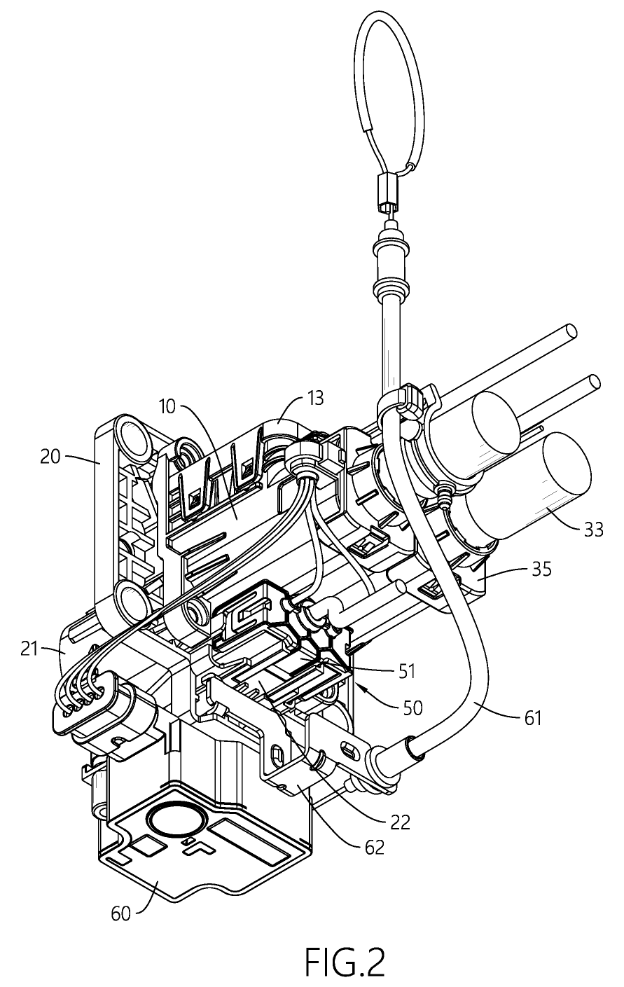

With reference to FIG. 1 to FIG. 3, a modular charging connector in accordance with the present invention comprises an integrating body 10, a socket body 20, an AC-DC terminal parallel module 30, a thermoconductive temperature detecting module 40, and a ground and low voltage signal module 50. The integrating body 10 is combined with the socket body 20. The AC-DC terminal parallel module 30 and the thermoconductive temperature detecting module 40 are mounted in the integrating body 10 at the same time. The thermoconductive temperature detecting module 40 thermally contacts the DC/AC terminals of the AC-DC terminal parallel module 30 to detect the operating temperature during charging through thermal conduction. The ground and low voltage signal module 50 forms a connector configuration to be combined with the socket body 20 and the integrating body 10. As mentioned above, the present invention is configured to efficiently utilize the space and facilitate ease in assembly by using the integrating body 10 as a core to connect the socket body 20 and each one of the modularized main components. In addition to the above components, the present invention may further comprise an electronic lock 60 in this embodiment.

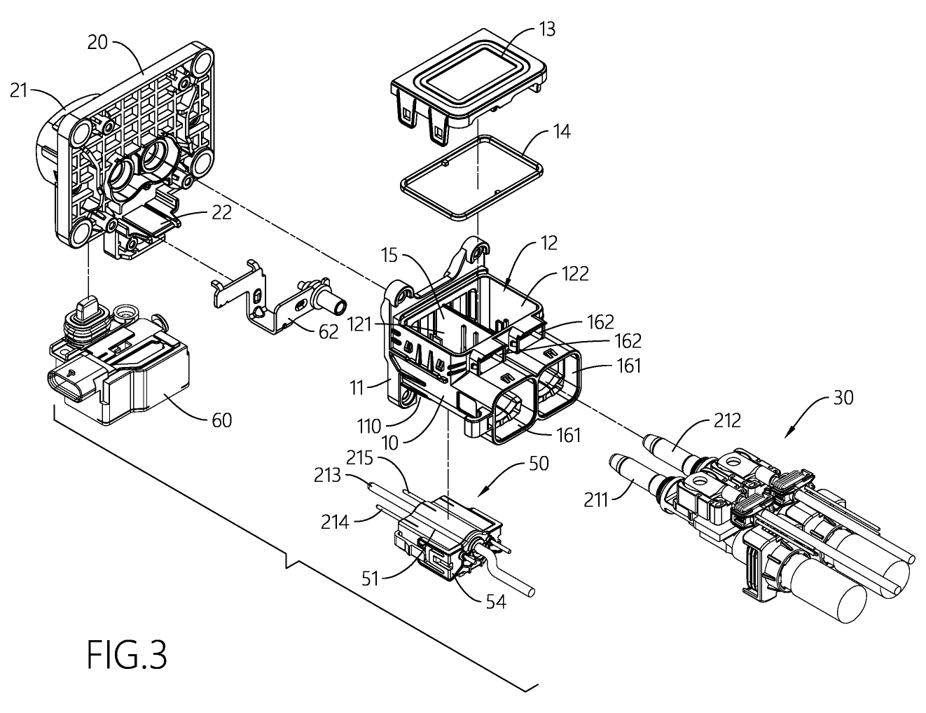

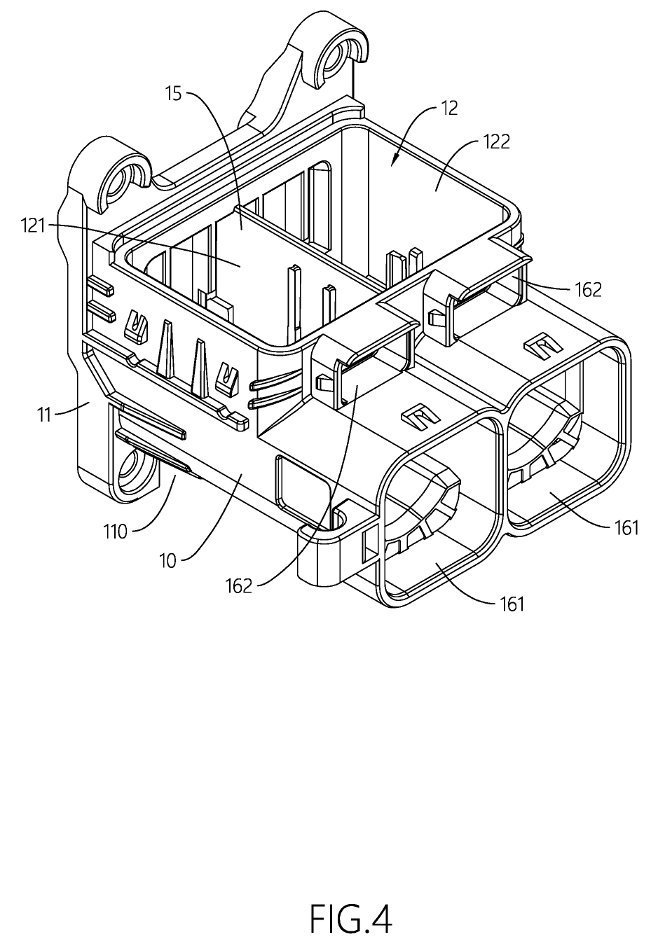

With reference to FIG. 3 and FIG. 4, the integrating body 10 comprises an inner side and an outer side. The inner side comprises a combining board 11. Multiples fixing holes are respectively formed in each one of the corners of the combining board 11 and are used for combination with the socket body 20. A containing chamber 12 is hollow and is formed between the inner side and the outer side. An upper opening is formed on the integrating body 10 above the containing chamber 12, and an upper cover 13 is detachably combined with the upper opening by engaging with each other. A waterproof gasket 14 is mounted between the upper cover 13 and an edge of the upper opening of the integrating body 10 for waterproof purposes.

A partition 15 is formed in the containing chamber 12 of the integrating body 10 and divides the containing chamber 12 into a first compartment 121 and a second compartment 122. Two DC cable sockets 161 and two AC cord sockets 162 are respectively formed on the outer side of the integrating body 10. The two DC cable sockets 161 and the two AC cord sockets 162 respectively connect between the first compartment 121 and the second compartment 122. In this embodiment, the two DC cable sockets 161 are located below the two AC cord sockets 162.

The socket body 20 is combined with the combining board 11 of the inner side of the integrating body 10. A socket 21 is located on a surface of the socket body 20. In this embodiment, the socket 21 complies with SAE J3400 standard and comprises a first charging terminal 211, a second charging terminal 212, a ground terminal 213, and two signal terminals 214, 215. The first and second charging terminals 211, 212 can be respectively configured as the charging terminals DC+/L1 and DC-/L2 of the DC or AC power supply. The two signal terminals 214, 215 are low-voltage signal terminals CP (Control pilot) and PP (Proximity pilot) that comply with the SAE J3400 standard. The first and second charging terminals 211, 212 pass through the combining board 11 of the integrating body 10 and extend into the containing chamber 12 to be electrically connected to the AC-DC terminal parallel module 30. The ground terminal 213 and the two signal terminals 214,215 are electrically connected to the ground and low voltage signal module 50.

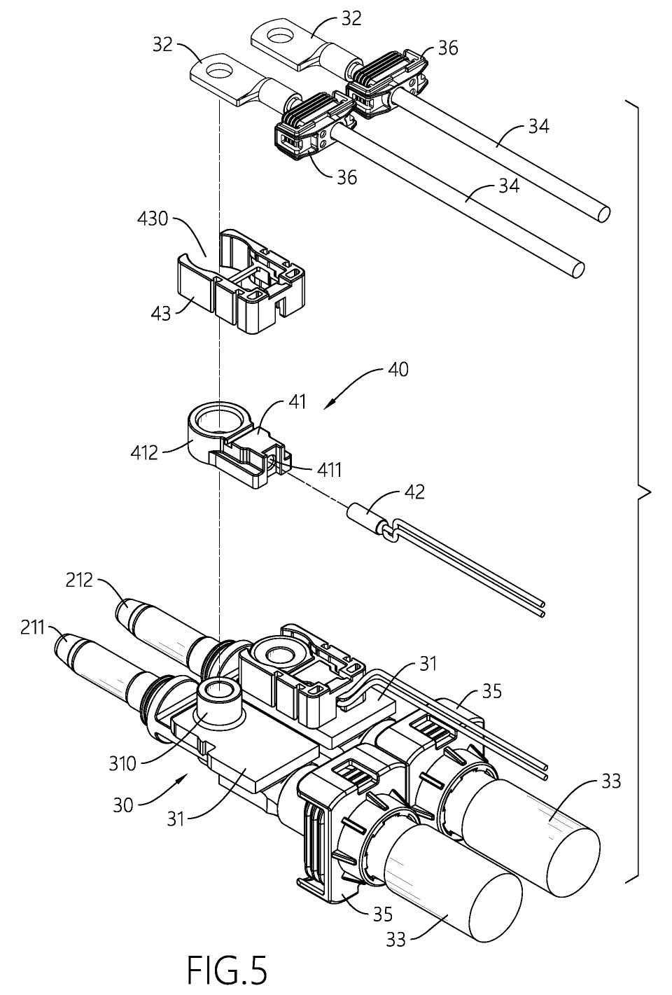

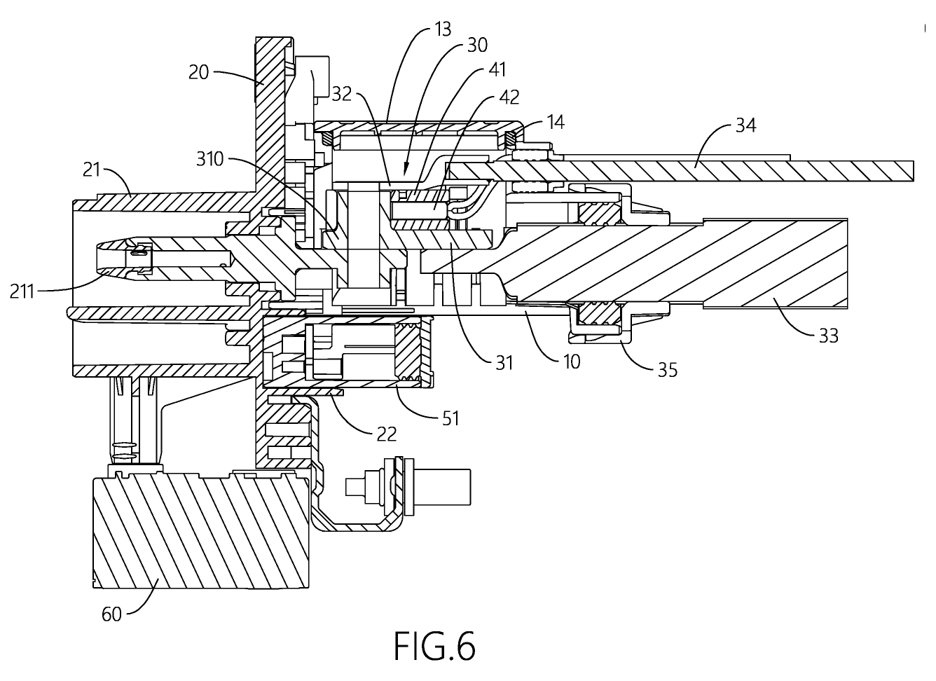

With reference to FIG. 5 and FIG. 6, the AC-DC terminal parallel module 30 comprises two DC terminals 31 and two AC terminals 32. The two DC terminals 31 are respectively connected to an end of the first charging terminal 211 and an end of the second charging terminal 212. The two AC terminals 32 are respectively connected to the end of the first charging terminal 211 and the end of the second charging terminal 212. Parallel connecting parts are respectively located in the first compartment 121 and the second compartment 122 of the integrating body 10. In this embodiment, each one of the DC terminals 31 is plate-shaped. A connecting part 310 is hollow, cylindrical and is formed on an end of each one of the DC terminals 31, and each one of the DC terminals 31 is connected to a respective one of the AC terminals 32 through a top end of the connecting part 310. An end of the first charging terminal 211 and an end of the second charging terminal 212 are respectively electrically connected to bottoms of the ends of the two DC terminals 31 with the connecting parts 310. In this state, the first charging terminal 211 and the second charging terminal 212 are respectively connected to the two DC terminals 31 and the two AC terminals 32. In this embodiment, the first charging terminal 211 and the second charging terminal 212 are first combined with the AC-DC terminal parallel module 30, and then extended into the socket 21 of the socket body 20 through the integrating body 10 during assembly.

The thermoconductive temperature detecting module 40 is mounted in the containing chamber 12 of the integrating body 10. The thermoconductive temperature detecting module 40 comprises two thermoconductive units 41 and two temperature sensors 42. The two thermoconductive units 41 are made of thermally conductive silicone and are blocks, and the two thermoconductive units 41 are respectively located in the first compartment 121 and the second compartment 122 of the integrating body 10. A through-hole 411 is formed at an end of each one of the two thermoconductive units 41 for a respective one of the two temperature sensors 42 to be mounted through in a shape-matching and thermally contacting manner. A contacting part 412 is cylindrical and is formed at another end of each one of the two thermoconductive units 41 and sleeves the connecting part 310 of a respective one of the DC terminals 31 in a shape-matching and thermally contacting manner. Therefore, the thermoconductive units 41 are located between the DC terminals 31 and the AC terminals 32 and in thermal contact. Since the thermoconductive units 41 are adjacent to the connection between the DC terminals 31 and the AC terminals 32 and the first charging terminal 211 and the second charging terminal 212, the operating temperature of the AC-DC terminal parallel module 30 can be accurately sensed.

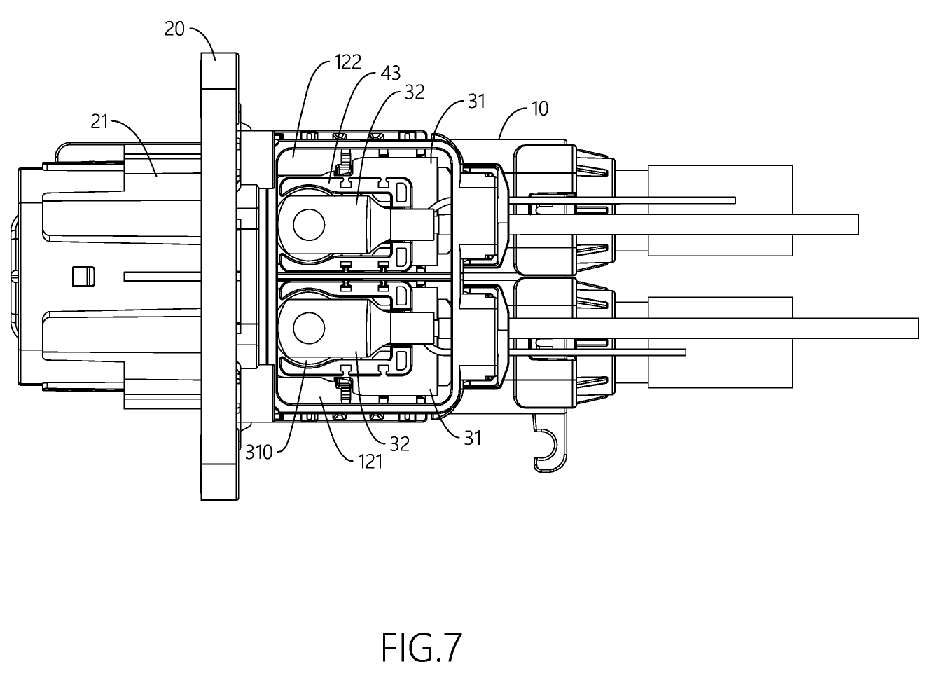

In this embodiment, to further fix the thermoconductive units 41 between the DC terminals 31 and the AC terminals 32, the thermoconductive temperature detecting module 40 comprises two fixing units 43. An accommodating slot 430 is formed in each one of the fixing units 43. The accommodating slot 430 can cover the thermoconductive unit 41 in a contour-matching manner but expose the top surface and the bottom surface of the thermoconductive unit 41 to contact the DC terminal 31 and the AC terminal 32. As shown in FIG. 7, the two fixing units 43 can accommodate the two thermoconductive units 41 and the temperature sensors 42 respectively in the first compartment 121 and the second compartment 122 of the integrating body 10, thereby firmly installing the thermoconductive units 41 and the temperature sensors 42 in the containing chamber 12 of the integrating body 10.

With reference to FIG. 3 and FIG. 6, the two DC terminals 31 are respectively connected to two direct current cables 33, and the two AC terminals 32 are respectively connected to two alternating current cords 34. The two direct current cables 33 respectively pass through two through-holes of two cable covers 35, and then the two direct current cables 33 are inserted into the containing chamber 12 through the two DC cable sockets 161 of the integrating body 10 and connected to the two DC terminals 31 respectively. The two direct current cables 33 and the two DC terminals 31 can be respectively connected by welding. Corresponding multiple second male buckles and multiple second female buckles are respectively formed on the two cable covers 35 and the two DC cable sockets 161 to engage with each other to fix the direct current cables 33 therebetween. When diameters of the through-holes of the cable covers 35 are different, copper cables or aluminum cables of different diameters can be used, such as 50mm2, 70mm2, or 95mm2. The two alternating current cords 34 respectively pass through two through-holes of two cord covers 36, and then the two alternating current cords 34 are inserted into the containing chamber 12 through the two AC cord sockets 162 of the integrating body 10 and connected to the two AC terminals 32 respectively. Corresponding multiple first male buckles and multiple first female buckles are respectively formed on the two cord covers 36 and the two AC cord sockets 162 to engage with each other to fix the alternating current cords 34 therebetween.

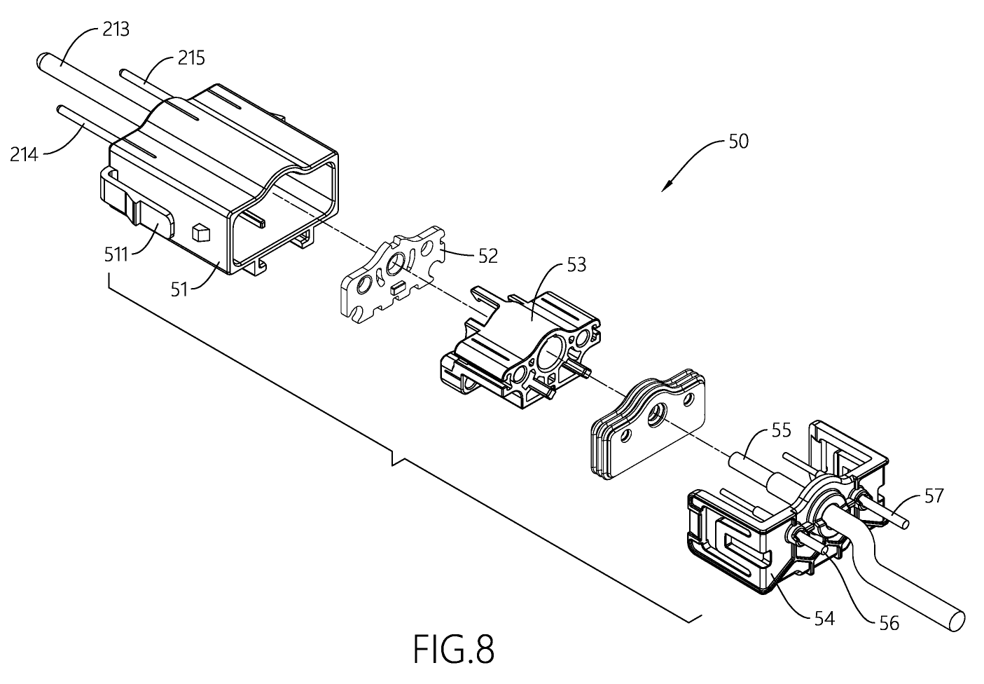

With reference to FIG. 3 and FIG. 8, the ground and low voltage signal module 50 comprises an outer casing 51, a circuit board 52, and an isolating unit 53. The outer casing 51 is hollow, and the circuit board 52 and the isolating unit 53 are mounted in the outer casing 51. The ground terminal 213 and the two signal terminals 214, 215 of the socket 21 penetrate from an end of the outer casing 51 and pass through the circuit board 52 and the isolating unit 53 successively. The ground terminal 213 and the two signal terminals 214, 215 are electrically connected to the circuit board 52. To facilitate assembly, the ground terminal 213 and the two signal terminals 214, 215 of the socket 21 are first mounted on the outer casing 51 to form a connector configuration. When the ground and low voltage signal module 50 is combined with the socket body 20, the ground terminal 213 and the two signal terminals 214, 215 extend into the socket 21.

After the ground terminal 213 and the two signal terminals 214, 215 pass through the isolating unit 53, the ground terminal 213 and the two signal terminals 214, 215 are isolated from each other through the isolating unit 53. In this embodiment, a wire guide cover 54 is mounted on another end of the outer casing 51. The wire guide cover 54 is a board with two lateral wings extending on two ends of said board. Multiple wire holes are formed on the board, and a ground wire 55 and two signal wires 56, 57 are respectively mounted through the wire holes. The ground wire 55 and the two signal wires 56, 57 are respectively electrically connected to the ground terminal 213 and the two signal terminals 214, 215 of the isolating unit 53. Corresponding multiples third male buckles and multiples third female buckles are respectively formed on the two lateral wings of the wire guide cover 54 and the outer casing 51 at relative positions to engage with each other.

The ground and low voltage signal module 50 is simultaneously connected to the integrating body 10 and the socket body 20 through the outer casing 51. A top of the outer casing 51 and a bottom of the integrating body 10 are complementary with each other in a concave-and-convex manner, so that the outer casing 51 can be fitly mounted on the bottom of the integrating body 10. Two buckles 511 are compressible and respectively formed on ends close to the socket body 20 of two sides of the outer casing 51. A slot 110 is formed on a bottom of the combining board 11 of the integrating body 10. The width of the slot 110 matches the width of the outer casing 51 at the portion with the buckles 511, so that the outer casing 51 can pass through the slot 110. After the outer casing 51 passes through the slot 110, the buckles on the two sides of the outer casing 51 will be buckled against an edge of the slot 110. A supporting board 22 extending backward is formed on a lower edge of the socket body 20. When an end of the outer casing 51 passes through the slot 110 of the integrating body 10, the bottom of said end of the outer casing 51 will be supported by the supporting board 22 of the socket body 20 at the same time, thereby the ground and low voltage signal module 50 connecting the integrating body 10 and the socket body 20.

With reference to FIG. 1 to FIG. 3, the socket body 20 comprises an electronic lock 60 mounted below the socket 21. A locking hole 210 is formed on the bottom of the socket 2. When the socket 21 is to be connected to a charging plug for charging, the lock tongue of the electronic lock 60 will extend into the locking hole 210 on the bottom of the socket 21 to lock, thereby preventing the charging plug from being arbitrarily removed, ensuring charging safety. In addition, to be able to manually unlock in an emergency, the electronic lock 60 comprises a pull rope 61. The pull rope 61 passes through a pull rope holder 62 mounted below the socket body 20 to limit the position and direction of the wire outlet.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A modular charging connector comprising:
an integrating body comprising an inner side and an outer side; a containing chamber being hollow and formed between the inner side and outer side;
a socket body combined with the inner side of the integrating body, and the socket body comprising a socket; the socket located on the socket body and comprising a first charging terminal, a second charging terminal, a ground terminal and two signal terminals;
an AC-DC terminal parallel module comprising two DC terminals and two AC terminals; the DC terminals respectively connected in parallel to an end of the first charging terminal and an end of the second charging terminal; the AC terminals respectively connected in parallel to the end of the first charging terminal and the end of the second charging terminal; parallel connecting parts located in the containing chamber of the integrating body;
a thermoconductive temperature detecting module comprising two thermoconductive units and two temperature sensors; the thermoconductive units mounted in the containing chamber of the integrating body and respectively thermally contacting the parallel connecting parts of the DC terminals and/or the parallel connecting parts of the AC terminals; the temperature sensors respectively mounted through the thermoconductive units;
a ground and low voltage signal module comprising an outer casing and a circuit board mounted in the outer casing; the ground terminal of the socket and the signal terminals of the socket mounted in the outer casing; an end of the ground terminal and an end of each one of the signal terminals passing out the outer casing and configured as a connector; another end of the ground terminal and another end of each one of the signal terminals electrically connected to the circuit board of the outer casing.

2. The modular charging connector as claimed in claim 1, wherein:
each one of the DC terminals of the AC-DC terminal parallel module is plate-shaped; a connecting part is hollow and cylindrical and is formed on an end of each one of the DC terminals, and each one of the DC terminals is connected to a respective one of the AC terminals through a top end of the connecting part; the end of the first charging terminal and the end of the second charging terminal are respectively electrically connected to bottoms of the ends of the DC terminals with the connecting parts;
the thermoconductive units of the thermoconductive temperature detecting module are blocks, a through-hole is formed at an end of each one of the thermoconductive units for a respective one of the temperature sensors to be mounted through in a shape-matching and thermally contacting manner; a contacting part is cylindrical and is formed at another end of each one of the thermoconductive units and sleeves the connecting part of a respective one of the DC terminals in a shape-matching and thermally contacting manner, so that the thermoconductive units are in thermal contact with the DC terminals and the AC terminals at the same time.

3. The modular charging connector as claimed in claim 1, wherein a partition is formed in the containing chamber of the integrating body, and the partition divides the containing chamber into a first compartment and a second compartment; the parallel connecting part, where the first charging terminal is connected to one of the DC terminals and one of the AC terminals, is located in the first compartment; the parallel connecting part, where the second charging terminal is connected to another one of the DC terminals and another one of the AC terminals, is located in the second compartment.

4. The modular charging connector as claimed in claim 2, wherein a partition is formed in the containing chamber of the integrating body, and the partition divides the containing chamber into a first compartment and a second compartment; the parallel connecting part, where the first charging terminal is connected to one of the DC terminals and one of the AC terminals, is located in the first compartment; the parallel connecting part, where the second charging terminal is connected to another one of the DC terminals and another one of the AC terminals, is located in the second compartment.

5. The modular charging connector as claimed in claim 3, wherein:
two DC cable sockets and two AC cord sockets are formed on the outer side of the integrating body; the DC cable sockets connect to the first compartment, and two cable covers are respectively located at locations where the DC cable sockets connect to the first compartment; the AC cord sockets connect to the second compartment, and the two cord covers are respectively located at locations where the AC cord sockets connect to the second compartment;
the two DC terminals of the AC-DC terminal parallel module are respectively connected to two direct current cables, and the two AC terminals are respectively connected to two alternating current cords;
the two direct current cables respectively pass through the cable covers, and are inserted into the first compartment and the second compartment by the two DC cable sockets of the integrating body, and then connected to the DC terminals; the two alternating current cords respectively pass through the cord covers, and are inserted into the first compartment and the second compartment by the two AC cord sockets of the integrating body, and then connected to the AC terminals.

6. The modular charging connector as claimed in claim 4, wherein:
two DC cable sockets and two AC cord sockets are formed on the outer side of the integrating body; the DC cable sockets connect to the first compartment, and two cable covers are respectively located at locations where the DC cable sockets connect to the first compartment; the AC cord sockets connect to the second compartment, and the two cord covers are respectively located at locations where the AC cord sockets connect to the second compartment;
the two DC terminals of the AC-DC terminal parallel module are respectively connected to two direct current cables, and the two AC terminals are respectively connected to two alternating current cords;
the two direct current cables respectively pass through the cable covers, and are inserted into the first compartment and the second compartment by the two DC cable sockets of the integrating body, and then connected to the DC terminals; the two alternating current cords respectively pass through the cord covers, and are inserted into the first compartment and the second compartment by the two AC cord sockets of the integrating body, and then connected to the AC terminals.

7. The modular charging connector as claimed in claim 5, wherein:
corresponding multiple first male buckles and multiple first female buckles are respectively formed on the two cord covers and the two AC cord sockets to engage with each other;
corresponding multiple second male buckles and multiple second female buckles are respectively formed on the two cable covers and the two DC cable sockets to engage with each other.

8. The modular charging connector as claimed in claim 6, wherein:
corresponding multiple first male buckles and multiple first female buckles are respectively formed on the two cord covers and the two AC cord sockets to engage with each other;
corresponding multiple second male buckles and multiple second female buckles are respectively formed on the two cable covers and the two DC cable sockets to engage with each other.

9. The modular charging connector as claimed in claim 1, wherein the ground and low voltage signal module comprises an isolating unit; the isolating unit is mounted in the outer casing; the ground terminal and the signal terminals in the socket penetrate from an end of the outer casing and successively pass through the circuit board and the isolating unit; the ground terminal and the signal terminals are electrically connected to the circuit board; the ground terminal and the signal terminals pass through the isolating unit and are isolated from each other through the isolating unit.

10. The modular charging connector as claimed in claim 8, wherein the ground and low voltage signal module comprises an isolating unit; the isolating unit is mounted in the outer casing; the ground terminal and the signal terminals in the socket penetrate from an end of the outer casing and successively pass through the circuit board and the isolating unit; the ground terminal and the signal terminals are electrically connected to the circuit board; the ground terminal and the signal terminals pass through the isolating unit and are isolated from each other through the isolating unit.

11. The modular charging connector as claimed in claim 9, wherein a wire guide cover is mounted on another end of the outer casing; the wire guide cover is a board with two lateral wings extending on two ends of said board; multiple wire holes are formed on the board, and a ground wire and two signal wires are respectively mounted through the wire holes; one end of the ground wire is electrically connected to one end of the ground terminal, and one end of each one of the two signal wires is electrically connected to one end of a respective one of the two signal terminals; said ends of the ground terminal and the two signal terminals extend out from the isolating unit; corresponding multiples third male buckles and multiples third female buckles are respectively formed on the two lateral wings of the wire guide cover and the outer casing at corresponding positions to engage with each other.

12. The modular charging connector as claimed in claim 10, wherein a wire guide cover is mounted on another end of the outer casing; the wire guide cover is a board with two lateral wings extending on two ends of said board; multiple wire holes are formed on the board, and a ground wire and two signal wires are respectively mounted through the wire holes; one end of the ground wire is electrically connected to one end of the ground terminal, and one end of each one of the two signal wires is electrically connected to one end of a respective one of the two signal terminals; said ends of the ground terminal and the two signal terminals extend out from the isolating unit; corresponding multiples third male buckles and multiples third female buckles are respectively formed on the two lateral wings of the wire guide cover and the outer casing at corresponding positions to engage with each other.

13. The modular charging connector as claimed in claim 9, wherein:
a bottom of the integrating body and a top of the outer casing are matching each other in a concave-and-convex manner; two buckles are compressible and respectively formed on ends of two sides of the outer casing, and said ends are close to the socket body;
the integrating body comprises a combining board located at an inner side thereof; a slot is formed on a bottom of the combining board; a width of the slot matches a distance between the two buckles, thereby facilitating the outer casing to pass through the slot; the buckles on the two sides of the outer casing are buckled at an edge of the slot;
a supporting board extending backward is formed on a lower edge of the socket body and supports the outer casing.

14. The modular charging connector as claimed in claim 12, wherein:
a bottom of the integrating body and a top of the outer casing are matching each other in a concave-and-convex manner; two buckles are compressible and respectively formed on ends of two sides of the outer casing, and said ends are close to the socket body;
the integrating body comprises a combining board located at an inner side thereof; a slot is formed on a bottom of the combining board; a width of the slot matches a distance between the two buckles, thereby facilitating the outer casing to pass through the slot; the buckles on the two sides of the outer casing are buckled at an edge of the slot;
a supporting board extending backward is formed on a lower edge of the socket body and supports the outer casing.

15. The modular charging connector as claimed in claim 1, wherein an upper opening is formed on the integrating body above the containing chamber, and an upper cover is detachably combined with the upper opening; a waterproof gasket is mounted between the upper cover and an edge of the upper opening of the integrating body.

16. The modular charging connector as claimed in claim 14, wherein an upper opening is formed on the integrating body above the containing chamber, and an upper cover is detachably combined with the upper opening; a waterproof gasket is mounted between the upper cover and an edge of the upper opening of the integrating body.

17. The modular charging connector as claimed in claim 1, wherein:
an electronic lock is mounted below the socket of the socket body; a locking hole is formed on a bottom of the socket, and the locking hole is corresponding to a lock tongue of the electronic lock in location;
the electronic lock comprises a pull rope; the pull rope is mounted through a pull rope holder mounted below the socket body.

18. The modular charging connector as claimed in claim 16, wherein:
an electronic lock is mounted below the socket of the socket body; a locking hole is formed on a bottom of the socket, and the locking hole is corresponding to a lock tongue of the electronic lock in location;
the electronic lock comprises a pull rope; the pull rope is mounted through a pull rope holder mounted below the socket body.
